(19) United States
(12) Patent Application Publication
(10) Pub. No.: US 2022/0414805 A1
(43) Pub. Date: Dec. 29, 2022

(54) MARKETING AND ANALYTIC SYSTEM AND METHOD FOR REAL ESTATE INDUSTRY

(71) Applicant: HOMETAGZ, LLC, Fishers, IN (US)

(72) Inventor: Robert Milton Backus, II, Indianapolis, IN (US)

(73) Assignee: HOMETAGZ, LLC, Fishers, IN (US)

(21) Appl. No.: 17/846,741

(22) Filed: Jun. 22, 2022

Related U.S. Application Data
(60) Provisional application No. 63/214,282, filed on Jun. 24, 2021.

(51) Int. Cl. G06Q 50/16

(52) U.S. Cl. CPC G06Q 50/163

(57) ABSTRACT

The present invention involves a real estate marketing platform on a computer server having a processor and memory capable of executing software modules. A communications module sends and receives messages over a network. A property listing module has a plurality of data records with descriptive information about the property, such that the seller may enter information into the data records and the buyer may access the data records. A tag generation module for provides at least one tag associated with an element of the property lacking an association with any of the data records. The tag button module operates such that upon activation of the tag button, a reference to the information associated with the tag is sent to the activating party.

### CROSS-REFERENCE TO RELATED APPLICATIONS

The present application is a non-provisional application which claims priority under 35 U.S.C. § 119(e) of U.S. Patent Provisional Application Ser. No. 63/214,282, filed Jun. 24, 2021, the disclosures of which are incorporated by reference herein.

### BACKGROUND OF THE INVENTION

### Field of the Invention

The invention relates to the real estate industry and software used by that industry to facilitate transactions. More specifically, but not exclusively, the field of the invention is that of interactive software for providing information on real estate listings.

### Description of the Related Art

Real estate marketing and sales is facilitated by real estate brokers, their agents, and software listings. Traditional means of carrying out real estate marketing are replete with inefficiency and other shortcomings and limitations. These shortcomings include the inability of software listings to provide complete information needed for sellers to convey all aspects of their properties and for buyers to obtain information needed to evaluate potential purchases.

In the late 1800s, real estate brokers regularly gathered at the offices of their local associations to share information about properties they were trying to sell. They agreed to compensate other brokers who helped sell those properties, and the first multiple listing software service was born, based on a fundamental principle that's unique to organized real estate: Help me sell my inventory and I'll help you sell yours. In the United States a multiple listing service, or “MLS,” is a collective activity operated by and for many parties, for example individual broker associations, regional multi-association conglomerates or independent cooperatives of real estate brokerages—there is no single authoritative MLS. However, there is a data standard for MLS systems. The Real Estate Standards Organization provides the Data Dictionary for common real estate terms and data structures, and the RESO Web API for data transport.

One benefit of MLS systems is that an MLS subscriber may search an MLS and retrieve information from the fields of the Data Dictionary about all homes for sale by all participating brokers. MLS systems contain hundreds of fields of information about the features of a property. These fields are determined by real estate professionals who are knowledgeable and experienced in that local marketplace.

Most MLS systems restrict membership and access to real estate brokers (and their agents) who are appropriately licensed by the state, are members of a local board or association of real estate brokers, and/or are members of the applicable national trade association. Access is becoming more open (e.g., without joining the local board) as Internet sites offer the public the ability to view portions of MLS listings. There still remains some limitation to access to information within MLSs; generally, only agents who are compensated proportional to the value of the sale have uninhibited access to the MLS database. Many public Web forums have a limited ability in terms of reviewing comparable properties, past sales prices or monthly supply statistics. Further, the constraints of the Data Dictionary do not allow for unique features of a particular portion of a real estate property to be conveyed to other brokers and/or purchasers because the unique feature is difficult or impossible to associate with the aspect of the real estate property that is pertinent,

Accordingly, a marketing system and method is needed where a seller may generate complete property information that is accessible quickly and efficiently to show to a seller all the relevant characteristics of the real estate.

### SUMMARY OF THE INVENTION

The present invention involves a computer server for providing a real estate marketing platform. The computer server comprises a processor and memory capable of executing software modules, with a communications module capable of sending and receiving messages over a network. The software modules include a property listing module having a plurality of data records with descriptive information about the property. This allows the seller or its agent to enter information into the data records, and additionally provides the buyer may access the data records with content beyond the conventional content available through the MLS listings. Another software module provides tags, with each tag being associated with an element of the property lacking an association with any of the data records. A further software module is responsive to user activation of the tags, so that upon activation of the tag button, a reference to the information associated with the tag is sent to an activating party.

Further aspects of the computer server involve the tag button module obtaining tracking information regarding the activating party. The tag button module associates the tracking information with the element associated with the activated tag.

Another aspect of the computer server involves the tag generation module which includes enhanced descriptive information to be associated with the element. The enhanced descriptive information may include rich text, image information, a data file, and/or video information.

The tag button module is responsive to the manual activation of a tag button on one of a smartphone and tablet, or alternatively to a cursor activation of one of a personal computer and computer terminal. The tag generation module provides a code allowing for access to enhanced information relating to the element, for example providing disclosure information associated with the element associated with the activated tag. The property listing module provides access to multiple listing service (MLS) data base information in combination with enhanced information incapable of storage in the MLS data base.

Further aspects of the invention relate to a method of using a computer to implement a real estate marketing system for a seller to facilitate a listing of a real estate property to a buyer. The method comprises the steps of providing a property listing, a tag, a tag information entry, and a tag button activation. The property listing has a plurality of data records with descriptive information about the property, such that the seller may enter information into the data records and the buyer may access the data records. The tag is associated with an element of the property, wherein that information about the element is lacking an association with any of the data records in conventional MLS listings. The information entry allows the seller to enter information relating to any tagged element. The tag button operates such that upon activation, the system provides a reference link to the buyer of the information associated with the tag.

In further aspects of the method, tracking information regarding the activating party of the tag button may be collected, and may be associated with the element associated with the activated tag. The information entry allows the seller or its agent to associate enhanced descriptive information with each element. The enhanced descriptive information may be rich text, image information, a data file, and/or video information. The tag button may be responsive to the manual activation of a tag button on one of a smartphone and tablet, and/or to a cursor activation of one of a personal computer and computer terminal. A further step of the method may involve providing a code allowing for access to enhanced information relating to the element.

Providing information entry may include providing the ability to associate disclosure information with the element of the activated tag. Also, providing a property listing may include providing access to multiple listing service (MLS) data base information in combination with enhanced information incapable of storage in the MLS data base.

Further aspects of the present invention involve providing the seller and/or its agent the ability to tag features, disclosures, general info, and for sale items allowing the buyer to navigate and explore the tags on their own via swiping and tapping on their phone, or the seller can assign unique QR codes/links to particular rooms or tags to send buyers directly to the content. This system allows sellers and/or its agents to attach a standard MLS listing document as the standardized property information directly along with seller-provided knowledge that has not been otherwise obtainable. The seller and/or its agent may then present information element specific in the most meaningful way. This system provides multiple options to give flexibility in the best way to show value.

The analytics and tracking available through the system allow sellers and/or their agents to evaluate marketing strategies via the system to monitor where listing traffic is coming from, and what elements of the listing are driving that traffic.

### BRIEF DESCRIPTION OF THE DRAWINGS

The above mentioned and other features and objects of this invention, either alone or in combinations of two or more, and the manner of attaining them, will become more apparent and the invention itself will be better understood by reference to the following description of an embodiment of the invention taken in conjunction with the accompanying drawings, wherein:

FIG. 1 is a schematic diagrammatic view of a network system in which embodiments of the present invention may be utilized.

FIG. 2 is a block diagram of a computing system (either a server or client, or both, as appropriate), with optional input devices (e.g., keyboard, mouse, touch screen, etc.) and output devices, hardware, network connections, one or more processors, and memory/storage for data and modules, etc. which may be utilized in conjunction with embodiments of the present invention.

FIG. 3 is a schematic diagram of the operation of the present invention relating to tagged objects in a real estate property/listing.

FIG. 4A is a smart phone screen shot that illustrates a main property page of the marketing and analytic system.

FIG. 4B is a schematic diagram that illustrates a view of where the property is located on a map.

FIG. 4C is a graphic map that illustrates a satellite view of the property.

FIG. 5 is a schematic diagram that illustrates a QR code and a computing device such as a mobile phone, laptop, desktop or tablet.

FIG. 6 is a computer terminal screen shot that illustrates a representative property listing.

FIG. 7 is a smartphone screen shot that illustrates a property introduction feature

FIG. 8 is a computer terminal screen shot that illustrates a contact agent/broker form.

FIG. 9 is a smartphone screen shot illustration of multiple spaces within a given property.

FIG. 10 is a smartphone screen shot that illustrates documentation related to a physical item that appears when a tag is selected.

FIG. 11 smartphone screen shot that illustrates tag written content that is organized by spaces.

Corresponding reference characters indicate corresponding parts throughout the several views. Although the drawings represent embodiments of the present invention, the drawings are not necessarily to scale and certain features may be exaggerated in order to better illustrate and explain the full scope of the present invention. The flow charts and screen shots are also representative in nature, and actual embodiments of the invention may include further features or steps not shown in the drawings. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings. While technology should continue to develop and many of the elements of the embodiments disclosed may be replaced by improved and enhanced items, the teaching of the present invention are inherent in the disclosure of the elements used in embodiments using technology available at the time of this disclosure.

The detailed descriptions which follow are presented in part in terms of algorithms and symbolic representations of operations on data bits within a computer memory representing alphanumeric characters or other information. A computer generally includes a processor for executing instructions and memory for storing instructions and data. When a general purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines and thus may operate through those control signals to transform materials far removed from the computer itself. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation. By changing the organization and operation of data structures and the algorithms for manipulating data in such structures, the fundamental operation of the computing system may be changed and improved.

Further, the manipulations performed are often referred to in terms, such as comparing or adding, commonly associated with mental operations performed by a human operator. No such capability of a human operator is necessary, or desirable in most cases, in any of the operations described herein which form part of embodiments of the present invention; the operations are machine operations. The operations of these algorithms are deterministic with the accuracy and complexity management that are not obtainable by human mental steps even though the language used to describe them in the detailed description below at some time references a mental step. This requirement for machine implementation for the practical application of the algorithms is understood by those persons of skill in this art as not a duplication of human thought, rather as significantly more than such duplication. Useful machines for performing the operations of one or more embodiments of the present invention include general purpose digital computers or other similar devices. In all cases the distinction between the method operations in operating a computer and the method of computation itself should be recognized. One or more embodiments of present invention relate to methods and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher level coding of the instructions that is interpreted to obtain the actual computer code. The software module may also include a hardware component, wherein some aspects of the algorithm are performed by the circuitry itself rather as a result of an instruction.

Some embodiments of the present invention also relate to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus unless explicitly indicated as requiring particular hardware. In some cases, the computer programs may communicate or relate to other programs or equipment through signals configured to particular protocols which may or may not require specific hardware or programming to interact. In particular, various general-purpose machines may be used with programs written in accordance with the teachings herein, or it may prove more convenient to construct more specialized apparatus to perform the required method steps. The required structure for a variety of these machines will appear from the description below.

Embodiments of the present invention may deal with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system may be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which may be activated directly or indirectly by the user. The terms “windowing environment”, “running in windows”, and “object oriented operating system” are used to denote a computer user interface in which information is manipulated and displayed on a video display such as within bounded regions on a raster scanned, liquid crystal matrix, or plasma based video display (or any similar type video display that may be developed). The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks may access the network resources, such as shared data files, common peripheral devices, and inter-workstation communication. Users activate computer programs or network resources to create “processes” which include both the general operation of the computer program along with specific operating characteristics determined by input variables and its environment. Similar to a process is an agent (sometimes called an intelligent agent), which is a process that gathers information or performs some other service without user intervention and on some regular schedule. Typically, an agent, using parameters typically provided by the user, searches locations either on the host machine or at some other point on a network, gathers the information relevant to the purpose of the agent, and presents it to the user on a periodic basis. A “module” refers to a portion of a computer system and/or software program that carries out one or more specific functions and may be used alone or combined with other modules of the same system or program.

The term “desktop” means a specific user interface which presents a menu or display of objects with associated settings for the user associated with the desktop. When the desktop accesses a network resource, which typically requires an application program to execute on the remote server, the desktop calls an Application Program Interface, or “API”, to allow the user to provide commands to the network resource and observe any output. The term “Browser” refers to a program which is not necessarily apparent to the user, but which is responsible for transmitting messages between the desktop and the network server and for displaying and interacting with the network user. Browsers are designed to utilize a communications protocol for transmission of text and graphic information over a world wide network of computers, namely the “World Wide Web” or simply the “Web”. Examples of Browsers compatible with one or more embodiments of the present invention include the Chrome browser program developed by Google Inc. of Mountain View, Calif. (Chrome is a trademark of Google Inc.), the Safari browser program developed by Apple Inc. of Cupertino, Calif. (Safari is a registered trademark of Apple Inc.), Internet Explorer program developed by Microsoft Corporation (Internet Explorer is a trademark of Microsoft Corporation), the Opera browser program created by Opera Software ASA, or the Firefox browser program distributed by the Mozilla Foundation (Firefox is a registered trademark of the Mozilla Foundation). Although the following description details such operations in terms of a graphic user interface of a Browser, one or more embodiments of the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method). Similarly, JavaScript Object Notation (JSON) may be used to convert between data file formats.

The terms “personal digital assistant”, or “PDA”, or smartphone as defined above, means any handheld, mobile device that combines two or more of computing, telephone, fax, e-mail and networking features. The terms “wireless wide area network” or “WWAN” mean a wireless network that serves as the medium for the transmission of data between a handheld device and a computer. The term “synchronization” means the exchanging of information between a first device, e.g. a handheld device, and a second device, e.g. a desktop computer or a computer network, either via wires or wirelessly. Synchronization ensures that the data on both devices are identical (at least at the time of synchronization).

Data may also be synchronized between computer systems and telephony systems. Such systems are known and include keypad based data entry over a telephone line, voice recognition over a telephone line, and voice over internet protocol (“VoIP”). In this way, computer systems may recognize callers by associating particular numbers with known identities. More sophisticated call center software systems integrate computer information processing and telephony exchanges. Such systems initially were based on fixed wired telephony connections, but such systems have migrated to wireless technology.

In wireless wide area networks, communication primarily occurs through the transmission of radio signals over analog, digital cellular or personal communications service (“PCS”) networks. Signals may also be transmitted through microwaves and other electromagnetic waves. Much wireless data communication takes place across cellular systems using second generation technology such as code-division multiple access (“CDMA”), time division multiple access (“TDMA”), the Global System for Mobile Communications (“GSM”), Third Generation (wideband or “3G”), Fourth Generation (broadband or “4G”), personal digital cellular (“PDC”), or through packet- data technology over analog systems such as cellular digital packet data (“CDPD”) used on the Advance Mobile Phone Service (“AMPS”).

The terms “wireless application protocol” or “WAP” mean a universal specification to facilitate the delivery and presentation of web-based data on handheld and mobile devices with small user interfaces. “Mobile Software” refers to the software operating system which allows for application programs to be implemented on a mobile device such as a mobile telephone or PDA. Examples of Mobile Software are Java and Java ME (Java and JavaME are trademarks of Sun Microsystems, Inc. of Santa Clara, Calif.), BREW (BREW is a registered trademark of Qualcomm Incorporated of San Diego, Calif.), Windows Mobile (Windows is a registered trademark of Microsoft Corporation of Redmond, Wash.), Palm OS (Palm is a registered trademark of Palm, Inc. of Sunnyvale, Calif.), Symbian OS (Symbian is a registered trademark of Symbian Software Limited Corporation of London, United Kingdom), ANDROID OS (ANDROID is a registered trademark of Google, Inc. of Mountain View, Calif.), and iPhone OS (iPhone is a registered trademark of Apple, Inc. of Cupertino, Calif.) , and Windows Phone 7. “Mobile Apps” refers to software programs written for execution with Mobile Software.

In the following specification, the term “social network” may be used to refer to a multiple user computer software system that allows for relationships among and between users (individuals or members) and content assessable by the system. Generally, a social network is defined by the relationships among groups of individuals, and may include relationships ranging from casual acquaintances to close familial bonds. In addition, members may be other entities that may be linked with individuals. The logical structure of a social network may be represented using a graph structure. Each node of the graph may correspond to a member of the social network, or content assessable by the social network. Edges connecting two nodes represent a relationship between two individuals. In addition, the degree of separation between any two nodes is defined as the minimum number of hops required to traverse the graph from one node to the other. A degree of separation between two members is a measure of relatedness between the two members.

Social networks may comprise any of a variety of suitable arrangements. An entity or member of a social network may have a profile and that profile may represent the member in the social network. The social network may facilitate interaction between member profiles and allow associations or relationships between member profiles. Associations between member profiles may be one or more of a variety of types, such as friend, co-worker, family member, business associate, common-interest association, and common-geography association. Associations may also include intermediary relationships, such as friend of a friend, and degree of separation relationships, such as three degrees away. Associations between member profiles may be reciprocal associations. For example, a first member may invite another member to become associated with the first member and the other member may accept or reject the invitation. A member may also categorize or weigh the association with other member profiles, such as, for example, by assigning a level to the association. For example, for a friendship-type association, the member may assign a level, such as acquaintance, friend, good friend, and best friend, to the associations between the member's profile and other member profiles.

Each profile within a social network may contain entries, and each entry may comprise information associated with a profile. Examples of entries for a person profile may comprise contact information such as an email addresses, mailing address, instant messaging (or IM) name, or phone number; personal information such as relationship status, birth date, age, children, ethnicity, religion, political view, sense of humor, sexual orientation, fashion preferences, smoking habits, drinking habits, pets, hometown location, passions, sports, activities, favorite books, music, TV, or movie preferences, favorite cuisines; professional information such as skills, career, or job description; photographs of a person or other graphics associated with an entity; or any other information or documents describing, identifying, or otherwise associated with a profile. Entries for a business profile may comprise industry information such as market sector, customer base, location, or supplier information; financial information such as net profits, net worth, number of employees, stock performance; or other types of information and documents associated with the business profile.

A member profile may also contain rating information associated with the member. For example, the member may be rated or scored by other members of the social network in specific categories, such as humor, intelligence, fashion, trustworthiness, sexiness, and coolness. A member's category ratings may be contained in the member's profile. In one embodiment of the social network, a member may have fans. Fans may be other members who have indicated that they are “fans” of the member. Rating information may also include the number of fans of a member and identifiers of the fans. Rating information may also include the rate at which a member accumulated ratings or fans and how recently the member has been rated or acquired fans.

A member profile may also contain social network activity data associated with the member. Membership information may include information about a member's login patterns to the social network, such as the frequency that the member logs in to the social network and the member's most recent login to the social network. Membership information may also include information about the rate and frequency that a member profile gains associations to other member profiles. In a social network that comprises advertising or sponsorship, a member profile may contain consumer information. Consumer information may include the frequency, patterns, types, or number of purchases the member makes, or information about which advertisers or sponsors the member has accessed, patronized, or used.

A member profile may comprise data stored in memory. The profile, in addition to comprising data about the member, may also comprise data relating to others. For example, a member profile may contain an identification of associations or virtual links with other member profiles. In one embodiment, a member's social network profile may comprise a hyperlink associated with another member's profile. In one such association, the other member's profile may contain a reciprocal hyperlink associated with the first member's profile. A member's profile may also contain information excerpted from another associated member's profile, such as a thumbnail image of the associated member, his or her age, marital status, and location, as well as an indication of the number of members with which the associated member is associated. In one embodiment, a member's profile may comprise a list of other social network members' profiles with which the member wishes to be associated.

An association may be designated manually or automatically. For example, a member may designate associated members manually by selecting other profiles and indicating an association that may be recorded in the member's profile. According to one embodiment, associations may be established by an invitation and an acceptance of the invitation. For example, a first user may send an invitation to a second user inviting the second user to form an association with the first user. The second user may accept or reject the invitation. According to one embodiment, if the second user rejects the invitation, a one-way association may be formed between the first user and the second user. According to another embodiment, if the second user rejects the association, no association may be formed between the two users. Also, an association between two profiles may comprise an association automatically generated in response to a predetermined number of common entries, aspects, or elements in the two members' profiles. In one embodiment, a member profile may be associated with all of the other member profiles comprising a predetermined number or percentage of common entries, such as interests, hobbies, likes, dislikes, employers and/or habits. Associations designated manually by members of the social network, or associations designated automatically based on data input by one or more members of the social network, may be referred to as user established associations.

Examples of social networks include, but are not limited to, facebook, twitter, myspace, linkedin, google plus, google circles, and other systems. The exact terminology of certain features, such as associations, fans, profiles, etc. may vary from social network to social network, although there are several functional features that are common to the various terms. Thus, a particular social network may have more of less of the common features described above. In terms of the following disclosure, generally the use of the term “social network” encompasses a system that includes one or more of the foregoing features or their equivalents.

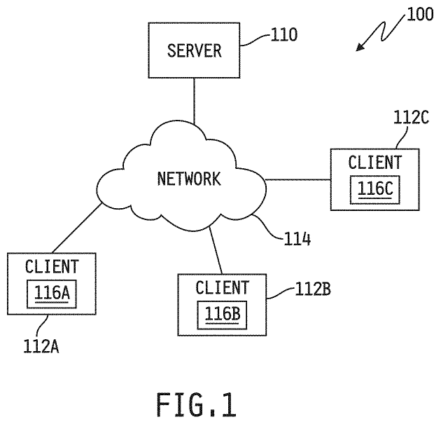

FIG. 1 is a high-level block diagram of a computing environment 100 according to one embodiment. FIG. 1 illustrates server 110 and three clients 112 connected by network 114. Only three clients 112 are shown in FIG. 1 in order to simplify and clarify the description. Embodiments of the computing environment 100 may have thousands or millions of clients 112 connected to network 114, for example the Internet. Users (not shown) may operate software 116 on one of clients 112 to both send and receive messages network 114 via server 110 and its associated communications equipment and software (not shown).

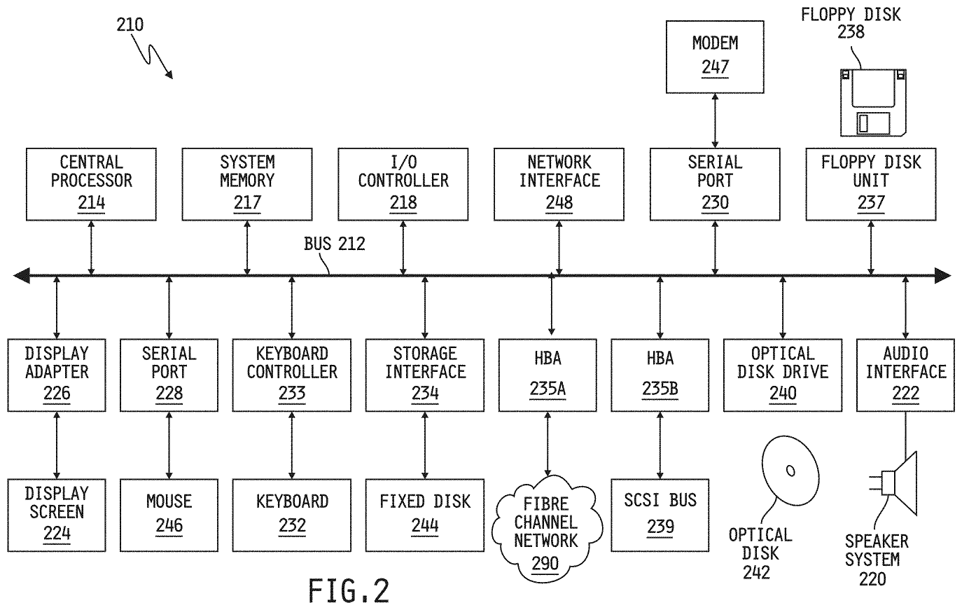

FIG. 2 depicts a block diagram of computer system 210 suitable for implementing server 110 or client 112. Computer system 210 includes bus 212 which interconnects major subsystems of computer system 210, such as central processor 214, system memory 217 (typically RAM, but which may also include ROM, flash RAM, or the like), input/output controller 218, external audio device, such as speaker system 220 via audio output interface 222, external device, such as display screen 224 via display adapter 226, serial ports 228 and 230, keyboard 232 (interfaced with keyboard controller 233), storage interface 234, disk drive 237 operative to receive floppy disk 238 (disk drive 237 is used to represent various type of removable memory such as flash drives, memory sticks and the like), host bus adapter (HBA) interface card 235A operative to connect with Fibre Channel network 290, host bus adapter (HBA) interface card 235B operative to connect to SCSI bus 239, and optical disk drive 240 operative to receive optical disk 242. Also included are mouse 246 (or other point-and-click device, coupled to bus 212 via serial port 228), modem 247 (coupled to bus 212 via serial port 230), and network interface 248 (coupled directly to bus 212).

Bus 212 allows data communication between central processor 214 and system memory 217, which may include read-only memory (ROM) or flash memory (neither shown), and random access memory (RAM) (not shown), as previously noted. RAM is generally the main memory into which operating system and application programs are loaded. ROM or flash memory may contain, among other software code, Basic Input- Output system (BIOS) which controls basic hardware operation such as interaction with peripheral components. Applications resident with computer system 210 are generally stored on and accessed via computer readable media, such as hard disk drives (e.g., fixed disk 244), optical drives (e.g., optical drive 240), floppy disk unit 237, or other storage medium. Additionally, applications may be in the form of electronic signals modulated in accordance with the application and data communication technology when accessed via network modem 247 or interface 248 or other telecommunications equipment (not shown).

Storage interface 234, as with other storage interfaces of computer system 210, may connect to standard computer readable media for storage and/or retrieval of information, such as fixed disk drive 244. Fixed disk drive 244 may be part of computer system 210 or may be separate and accessed through other interface systems. Modem 247 may provide direct connection to remote servers via telephone link or the Internet via an interne service provider (ISP) (not shown). Network interface 248 may provide direct connection to remote servers via direct network link to the Internet via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 2 need not be present to practice the present disclosure. Devices and subsystems may be interconnected in different ways from that shown in FIG. 2. Operation of a computer system such as that shown in FIG. 2 is readily known in the art and is not discussed in detail in this application. Software source and/or object codes to implement the present disclosure may be stored in computer-readable storage media such as one or more of system memory 217, fixed disk 244, optical disk 242, or floppy disk 238. The operating system provided on computer system 210 may be a variety or version of either MS-DOS® (MS-DOS is a registered trademark of Microsoft Corporation of Redmond, Wash.), WINDOWS® (WINDOWS is a registered trademark of Microsoft Corporation of Redmond, Wash.), OS/2® (OS/2 is a registered trademark of International Business Machines Corporation of Armonk, N.Y.), UNIX® (UNIX is a registered trademark of X/Open Company Limited of Reading, United Kingdom), Linux® (Linux is a registered trademark of Linus Torvalds of Portland, Oreg.), or other known or developed operating system. In some embodiments, computer system 210 may take the form of a tablet computer, typically in the form of a large display screen operated by touching the screen. In tablet computer alternative embodiments, the operating system may be iOS® (iOS is a registered trademark of Cisco Systems, Inc. of San Jose, Calif., used under license by Apple Corporation of Cupertino, Calif.), Android® (Android is a trademark of Google Inc. of Mountain View, Calif.), Blackberry® Tablet OS (Blackberry is a registered trademark of Research In Motion of Waterloo, Ontario, Canada), webOS (webOS is a trademark of Hewlett-Packard Development Company, L.P. of Texas), and/or other suitable tablet operating systems.

Moreover, regarding the signals described herein, those skilled in the art recognize that a signal may be directly transmitted from a first block to a second block, or a signal may be modified (e.g., amplified, attenuated, delayed, latched, buffered, inverted, filtered, or otherwise modified) between blocks. Although the signals of the above described embodiments are characterized as transmitted from one block to the next, other embodiments of the present disclosure may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

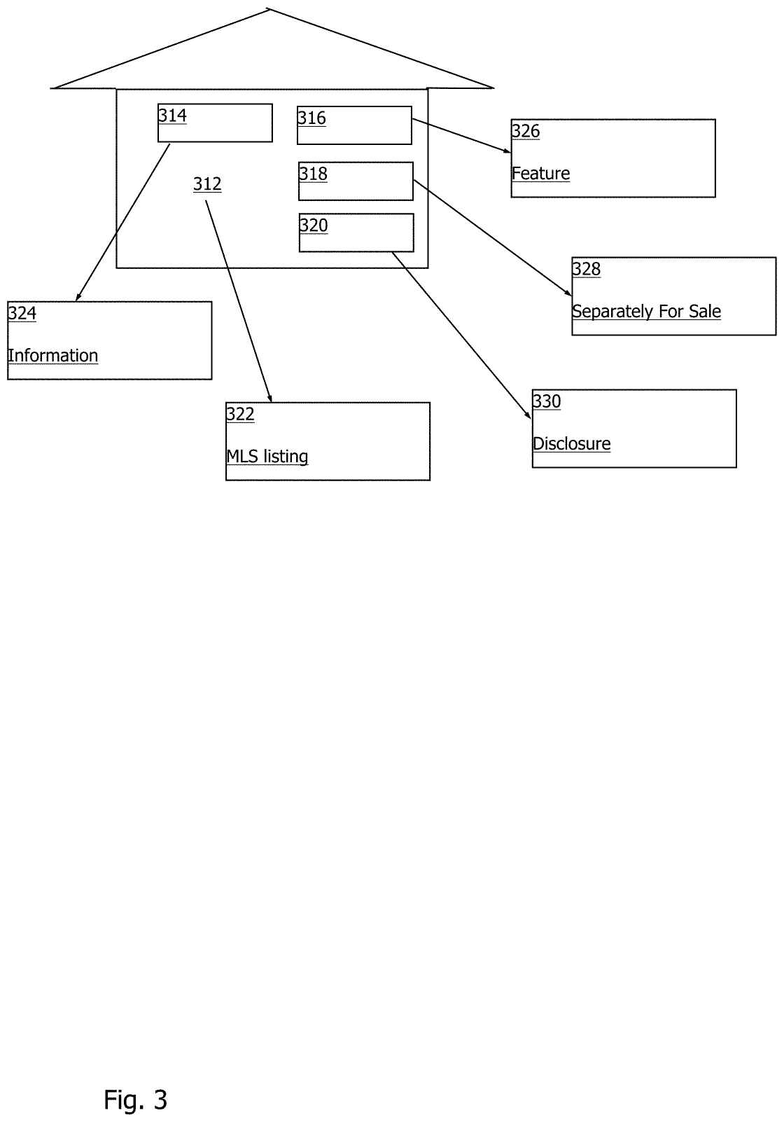

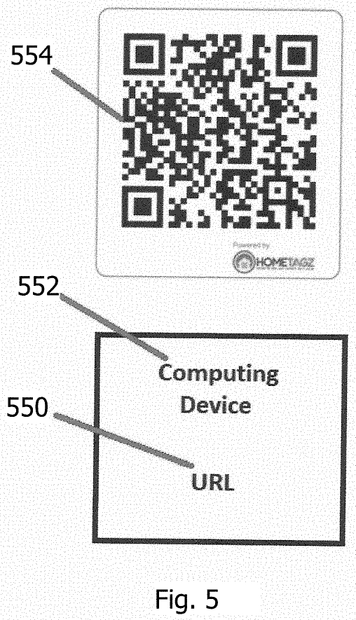

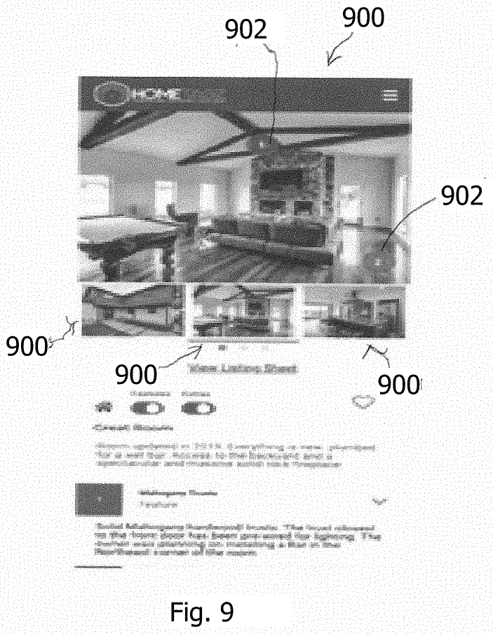

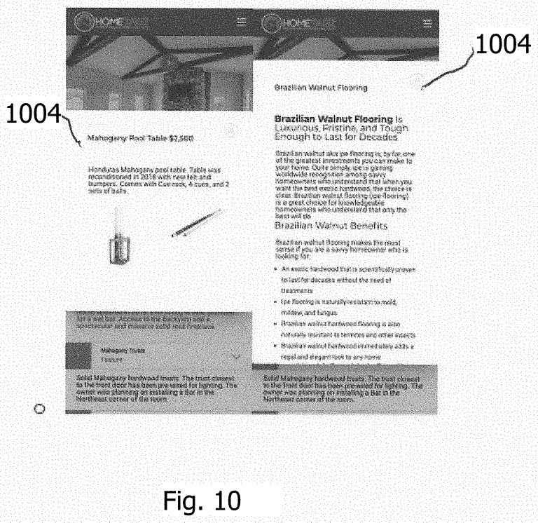

FIG. 3 shows the relationship between items in real estate property/listing 312. In the abstract representation of FIG. 3, item 312 may be, in one embodiment, an actual physical house or other building having tags 314, 316, 318, 320 (See tag 554 of FIG. 5 as one embodiment) that are related to further information relating to the aspect of item 312 to which the tag is physically attached. In another embodiment, computer listing 322 associated with item 312, and may be similar to an MLS listing, may have tags that are associated with portions of the display of the listing (see the detailed description of FIGS. 9 and 10).

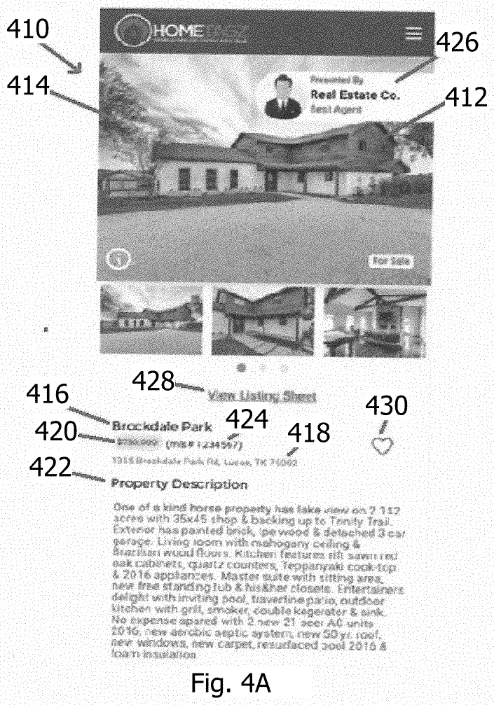

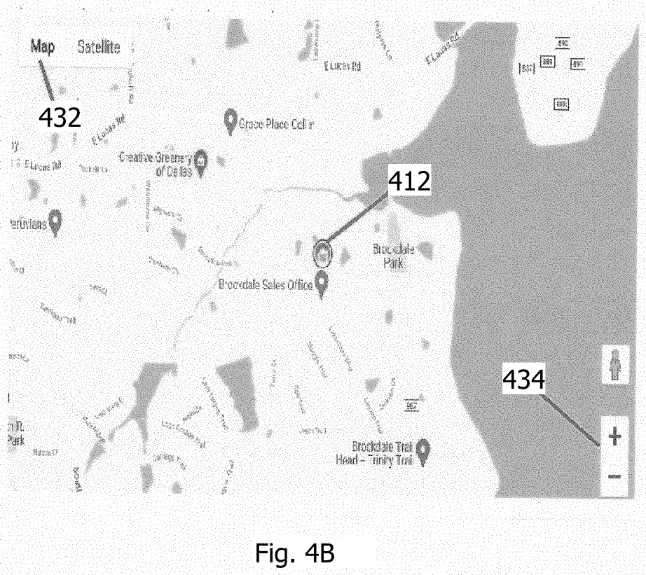

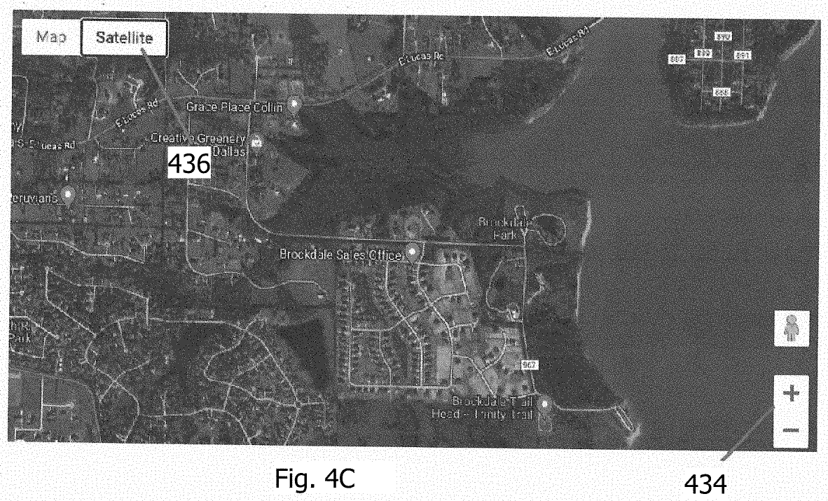

Referring to FIG. 4A, marketing and analytic system 410 is illustrated that is used to identify property 412 that is on the market for sale. System 410 may be configured on server 110 to provide information regarding property 412 to multiple clients 112, for example without limitation, for display on a personal computer, smartphone, tablet, computer terminal, and the like. FIG. 4A illustrates main property page 414 of the marketing and analytic system 410 that contains a collection of spaces and other media representing notable characteristics of property 412. Main property page 414 is created by an author, which in one form can comprise a real estate agent. As illustrated, main property page 414 includes a link to a plurality of images of property 412. Generally, as set forth in detail below, property 412 is identifiable by several descriptive items.

As illustrated, these descriptive items include the following items. First, and in no particular order, property 412 may be identified by property name 416. In the illustrated example, property name 416 is “Brockdale Park” but may be any name. Main property page 414 may also list address 418 associated with property 412. Further, main property page 414 may list listing price 420 of property 412. Main property page 414 may also include property description section 422 which contains a detailed description of certain features of property 412 that the author wants to highlight to an end user of marketing and analytic system 410.

Main property page 414 may also include multiple listing service (MLS) 424 number associated with property 412. MLS 424 is a database established by cooperating real estate agents to provide data about properties for sale. MLS 424 allows real estate agents to see one another's listings of properties 412 for sale with the goal of connecting homebuyers to sellers. As further illustrated, main property page 414 may also include author display 426 that is associated with the author of main property page 414. Main property page 414 may also include listing sheet 428 link that allows the end user to view listing sheet 428 (as will be discussed in detail below) associated with property 412. In addition, main property page 414 also includes like icon 430 that allows the end user to like the property 412 if they are interested in the property 412, for example without limitation by posting to the end user's social media account.

Referring to FIG. 4B, map view 432 of property 412 is illustrated that may be located at the bottom of main property page 414. Map view 432 shows the roads that lead to property 412. Other general features surrounding property 412 are illustrated in the map view. Map view 432 may include zoom feature 434 that allows the user to zoom in and out of map view 432. Referring to FIG. 4C, satellite view 436 of property 412 is illustrated. Satellite view 436 is an image of Earth taken by a satellite orbiting Earth and is a photo taken of various areas including where property 412 is located. Satellite view 436 may also include zoom feature 434 that allows the user to zoom in and out of satellite view 432.

Referring to FIG. 5, marketing and analytic system 10 allows items in property 312, 412 to be accessible via a public web Uniform Resource Locator (URL) 550 through computing device 552 (which may be a personal computer, smartphone, tablet, etc.). URL 550, colloquially termed a web address, is a reference to a web resource that specifies its location on a computer network and a mechanism for retrieving it. URL 550 may refer to a web page, and additionally or in the alternative may also be used to refer to file transfers, email, database access, and many other applications capable of delivering information over a network. In some embodiments, URL 550 is encoded on tag 554, such as on a physical label with a quick response, or QR, code 554 or other barcode or other type of machine-readable optical label that may contain information about the item to which it is attached, for example without limitation data for a locator, identifier, or tracker that points to a website or application having relevant information.

For example, without limitation, when a prospective buyer is touring a property with several items, the prospective buyer may see several tags 554 on various items in the property. In one exemplary embodiment, one tag 554 may be displayed on a dining room table, and when the prospective buyer scans tag 554 the resulting reference may include information on the separate sale of that dining room table (price and terms of sale, etc.). In another exemplary embodiment, another tag 554 may be displayed on a kitchen faucet, and when a prospective buyer scans that tag 554 the resulting reference may include a description of a separate spot water heating device that provides immediate hot water to that faucet wherein the heating device is built into the wall. In a further exemplary embodiment, a further tag 554 may be displayed on an attic doorway, and when the prospective buyer scans that tag 554 the resulting reference may include a disclosure of the unsuitability of the use of the attic for storage without significant upgrade to that portion of the property. In yet another exemplary embodiment, a yet further tag 554 may be attached to a banister of a property, and when the prospective buyer scans that tag 554 the resulting reference may include a description of a historical event or person involving that portion of the property.

Marketing and analytic system 410 provides tracking and analytics to the property seller and/or agent. In addition to conventional tracking and analytics, embodiments of system 410 track information access on the various tags and fields so that much more granular information may be conveyed to the property seller and/or agent. With the use of analytics specifically associated with discrete items of main property page 414 so that the buyer interaction with particular features may inform the property seller and/or agent of aspects of the property that might be further enhanced or improved to facilitate a real estate transaction on the property.

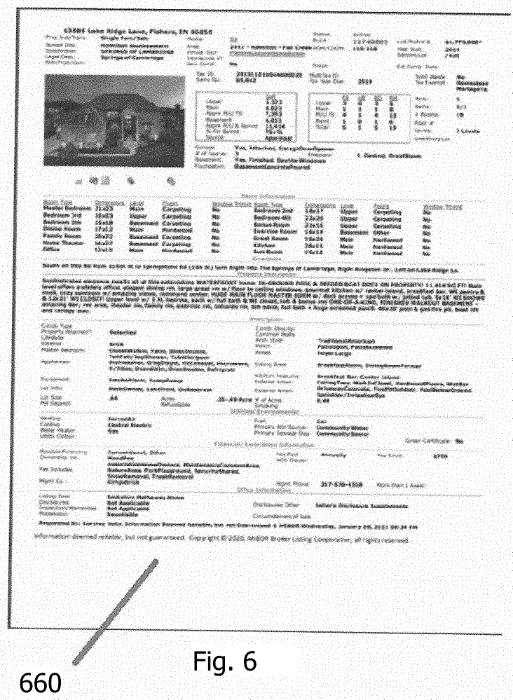

Marketing and analytic system 410 may deliver information related to property 412 to the computing device 552 as a progressive web application. Web URL 550 may be shared via social media, short message services (“SMS”—SMS is used to send text messages to mobile phones e.g. computing device 552), email. Further, additional documents in portable document file format (PDF) may be attached to property 412 which gives additional documentation about the specifications of property 412. Referring to FIG. 6, this provides the end user with one click access to property listing 660. Property listing 660 provides the agent with the ability to provide certain details about property 412. Conventionally, property listing 660 is generally an agreement that represents the right of a real estate agent or broker to handle the sale of real estate property 412 and to receive a fee or commission for services. There are various types of real estate listings 660.

A general or open listing is a right to sell that may be given to more than one agent or broker simultaneously. An exclusive agency listing is the right of one real estate agency to be the sole party, with the exception of the owner, who is permitted to sell the property during a particular period. Through an exclusive authorization to sell listing, one agency is given the sole authority to sell the property during a certain time period. The agency will receive a commission even if the owner finds the buyer during the time period. Thus, agents generally interact with prospective buyers to facilitate a transaction with their listed properties. By use of the analytics and tracking information on particular aspects of each property provided by embodiments of the present invention, such agents may become more effective in securing sales using the technology enabled by tracking and analytic system 410.

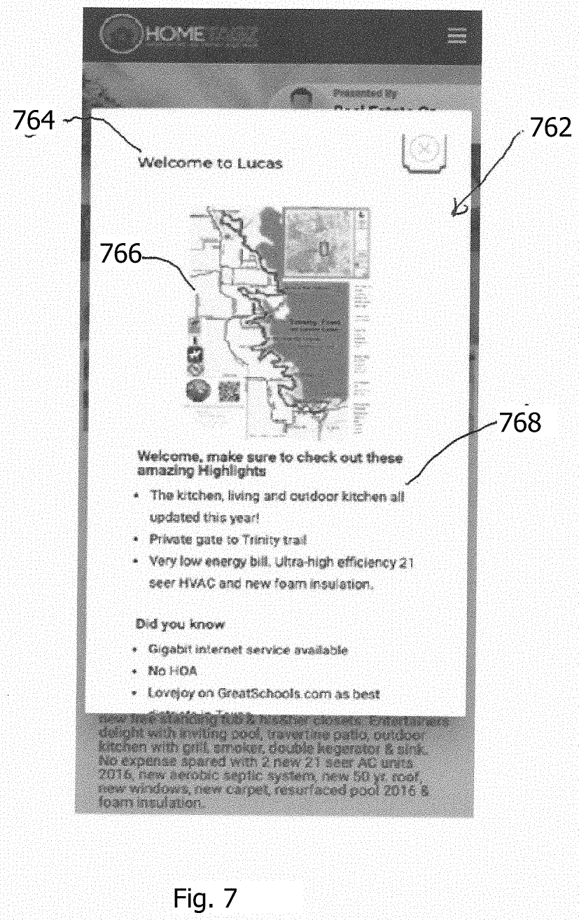

Referring to FIG. 7, property introduction 762 feature is provided that allows the author or agent to emphasize specific notable property characteristics prior to the end user entering the space. This extra focus is intended to influence and build excitement prior to the end user forming an opinion before they get a chance to entering the space. Property introduction feature 762 may include title 764, map 766, and property rich text description 768 (emphasis on important information using bold, italic, underlining, video, images, and bulleted formats). Property 412 may be saved (favorited) by the end users who want to be able to refer back to property 412 in the future, for example without limitation on a social network account.

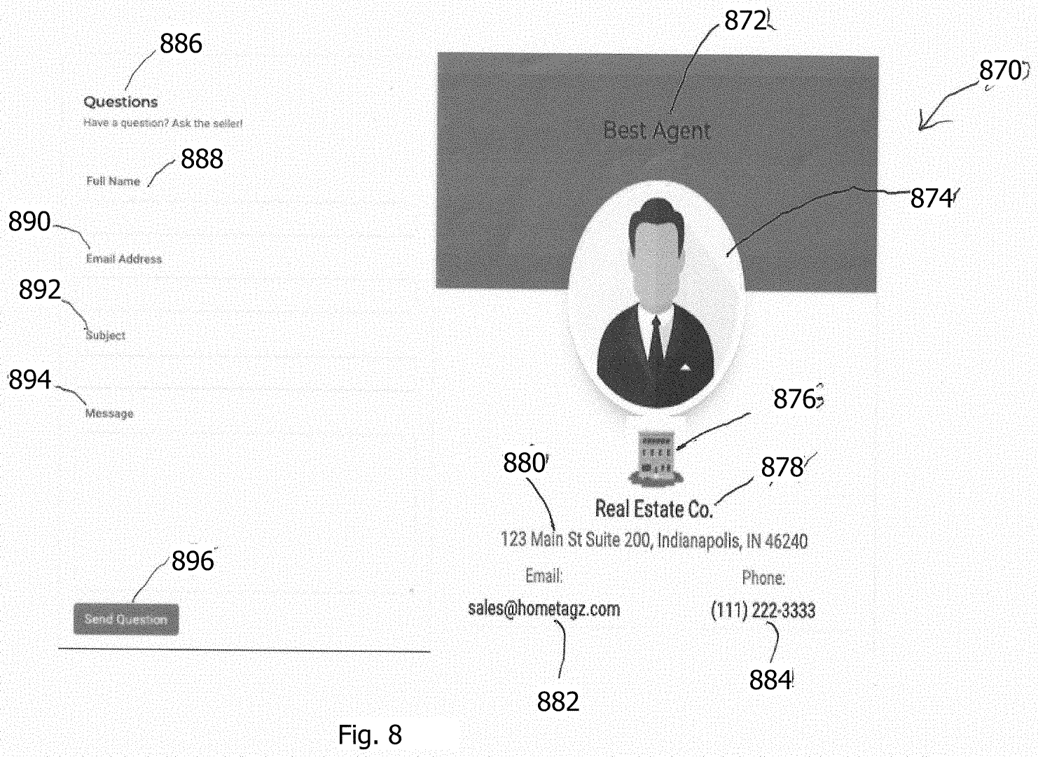

Referring to FIG. 8, contact agent/broker form 870 allows the end user to contact the agent/broker in various forms. Contact agent/broker form 870 lists name 872 of the broker, profile image 874 of the agent/broker, social media link 876, business name 878, address 880, for the agent/broker, email address 882, and phone number 884. Contact agent/broker form 870 also includes question section 886 having potential buyer entry field 888 for any potential buyer to enter their full name, email address entry field 890 for any potential buyer to enter an email address, subject entry field 892 for any potential buyer to enter the subject of the message, message entry field 894 for any potential buyer to type a message, and send question button 896 to transmit the information to the agent/broker.

Referring to FIG. 9, a plurality of spaces 900 are illustrated that represent a named location or physical item represented by the respective images. Potential buyers may interact with spaces 900 to learn more about each space 900. Each space 900 may include a title, a rich text description, one or more videos, and contextual content (“tags”). As discussed in greater detail below, tags 902 provide additional context in order to educate and avoid inaccurate assumptions on the physical characteristics of the physical items in each space 900. In addition to being able to provide relevant MLS information associated with the item in a conventional manner, such information may be enhanced with tags that may be activated by swiping or tapping on an item on a display screen, for example without limitation with fingers on a smartphone or tablet display, or a cursor on a computer terminal, to provide rich text, html, graphic, PDF, or other relevant information that an Agent may decide to include certain non-standard seller-provided knowledge that is not compatible with the MSL data standard.

Tags 902 add additional context to the physical characteristics of a physical item by placing one or more categories of tags 902 over the physical item. In embodiments of the present invention, at least four different types of tags 902 are used. One type of tag 902 is a feature tag which indicates and describes the enhanced progression of a physical item and how it has improved an overall state of the physical item. Another type of tag 902 is an information tag that provides information about the physical item not visible by looking at the physical item. A further type of tag 902 is a “For Sale” tag that indicates that the physical item is separately for sale, which otherwise not be known by looking at the item. Yet another type of tag 902 is a disclosure tag that indicates a flawed physical item that may or may not be visible to a potential buyer. It may describe a possible remedy and a current state of the physical item. Further types of tags 902 may be implemented as contemplated by the present invention to convey further information lacking conventional labels.

The context of tags 902 is delivered in various meaningful ways to achieve maximum impact on the potential buyer. One way information may be delivered to the potential buyer is in a rich text format. This is conventionally referred to as a “what you see is what you get” format. Editor control is used to allow the author to provide a rich text experience to the potential buyer. Emphasis on important information may be established by using bold, italic, underlining, and bullet points. Additional information be provided to the potential buyer using a photo album showing additional images of the physical item, e.g., showing a past state, a present state, images of various angles, one or more close up images, and details not available in the initial view prior to drilling down into the particular tag 902. In other forms, tags 902 may link the end user/potential buyer to a video about the physical item, a narrative about the physical item, or educational material relating to the origin or use of the physical item. Referring to FIG. 10, in other forms tags 902 may direct the end user to one or more documents 1004 providing further detail, warranty, cost, and proof around the details about the physical item.

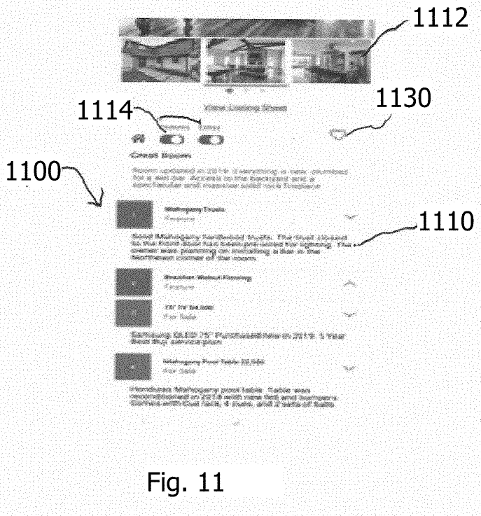

Referring to FIG. 11, tag content 1110 is organized by spaces 1100. Each space 1100 is represented by image 1112 with one or tags 902 placed in meaningful locations over image 1112. Tags 902 may be activated by a button or other similar user interface. Tag 1102 content is generally accessible in at least one of two ways. A first way involves a tap/click method in which the potential buyer taps or clicks on tag 902 with the computer cursor. An overlay appears over the space, connecting to the additional content associated with tag 902. Another method is a view scope method, wherein only one space can be in scope at any given time. Other display methods are also available as one of skill in computer technology would recognize. As illustrated, each view is formatted to deliver spaces information and tag context in a list view format and is accessible by scrolling the view, connecting tag 902 context to tags 902 by numerical value, color, and/or other identifiers. Tag 102 content may be collapsed and expanded. Toggle switches 1114 are available to toggle tag content on and off, removing it from view.

While one or more embodiments of this invention have been described as having an illustrative design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A computer server for providing a real estate marketing platform, said computer comprising:
a processor and memory capable of executing software modules
a communications module capable of sending and receiving messages over a network,
a property listing module having a plurality of data records with descriptive information about the property, such that the seller may enter information into the data records and the buyer may access the data records,
a tag generation module for providing at least one tag associated with an element of the property lacking an association with any of the data records, and
a tag button module that upon activation of the tag button, a reference to the information associated with the tag is sent to an activating party.

2. The computer server of claim 1 wherein the tag button module obtains tracking information regarding the activating party.

3. The computer server of claim 2 wherein the tag button module associates the tracking information with the element associated with the activated tag.

4. The computer server of claim 1 wherein the tag generation module includes enhanced descriptive information to be associated with the element.

5. The computer server of claim 4 wherein the enhanced descriptive information includes one of rich text, image information, a data file, and video information.

6. The computer server of claim 1 wherein the tag button module is responsive to the manual activation of a tag button on one of a smartphone and tablet.

7. The computer server of claim 1 wherein the tag button module is responsive to a cursor activation of one of a personal computer and computer terminal.

8. The computer server of claim 1 wherein the tag generation module provides a code allowing for access to enhanced information relating to the element.

9. The computer server of claim 1 wherein the tag generation module provides disclosure information associated with the element associated with the activated tag.

10. The computer server of claim 1 wherein the property listing module provides access to multiple listing service (MLS) data base information in combination with enhanced information incapable of storage in the MLS data base.

11. A method of using a computer to implement a real estate marketing system for a seller to facilitate a listing of a real estate property to a buyer, said method comprising the steps of:
providing a property listing having a plurality of data records with descriptive information about the property, such that the seller may enter information into the data records and the buyer may access the data records,
providing at least one tag associated with an element of the property lacking an association with any of the data records,
providing an information entry module for the seller to enter information relating to the tagged element, and
providing a tag button that upon activation of the tag button by an activating party, and providing a reference to the buyer of the information associated with the tag.

12. The method of claim 11 further comprising the step of obtaining tracking information regarding the activating party.

13. The method of claim 12 further including the step of associating the tracking information with the element associated with the activated tag.

14. The method of claim 11 wherein the step of providing an information entry module includes providing the ability to associate enhanced descriptive information with the element.

15. The method of claim 14 wherein the enhanced descriptive information includes one of rich text, image information, a data file, and video information.

16. The method of claim 11 wherein the step of providing a tag button includes being responsive to the manual activation of a tag button on one of a smartphone and tablet.

17. The method of claim 11 wherein the step of providing a tag button includes being responsive to a cursor activation of one of a personal computer and computer terminal.

18. The method of claim 11 wherein the step of providing a tag button includes providing a code allowing for access to enhanced information relating to the element.

19. The method of claim 11 wherein the step of providing an information entry module includes providing the ability to associate disclosure information with the element of the activated tag.

20. The method of claim 11 wherein the step of providing a property listing module includes providing access to multiple listing service (MLS) data base information in combination with enhanced information incapable of storage in the MLS data base.
